(19) United States
(12) Patent Application Publication
(10) Pub. No.: US 2008/0205363 A1
(43) Pub. Date: Aug. 28, 2008

(54) Method for operating a VoIP terminal device and a VoIP terminal device

(76) Inventors: Rainer Falk, Eching (DE); Florian Kohlmayer, Starnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/002,953

(22) Filed: Dec. 18, 2007

(30) Foreign Application Priority Data
Dec. 19, 2006 (EP) 06026369.6

(51) Int. Cl. H04Q 7/24

(52) U.S. Cl. 370/338

(57) ABSTRACT

In one aspect, a method for operating a cordless VoIP terminal device in a private network is provided. The VoIP terminal device is authorized to access the private network. Data stored on the VoIP terminal device is assessable via a standard interface for facilitating data access only after the VoIP terminal device has been successfully logged into the private network. A VoIP terminal device for carrying out the method is further provided.

### CROSS REFERENCE TO RELATED APPLICATIONS

This application claims priority of European Patent Office application No. 06026369.6 EP filed Dec. 19, 2006, which is incorporated by reference herein in its entirety.

### FIELD OF INVENTION

The invention relates to a method for operating a VoIP terminal device and a VoIP terminal device.

### BACKGROUND OF INVENTION

As a result, not least, of the spread and density of broadband Internet accesses, voice communication using Internet Protocol (IP)-based data networks has become more attractive. Thanks to the capabilities of local wireless networks, such as are offered for example by a Wireless Local Area Network (WLAN) constructed in accordance with the IEEE 802.11 standard or its derivatives, this form of communication, known as Voice over IP (VoIP), also makes possible cordless communication such as has until now been offered, for example, by devices constructed in accordance with the Digital Enhanced Cordless Telecommunications (DECT) standard. In a way similar to that with DECT devices, VoIP communication which is handled by means of a WLAN also permits cordless telephony in private networks, such as for example company networks.

### SUMMARY OF INVENTION

Particularly in company networks, however, there is an increased security requirement and at the same time also a higher risk that security vulnerabilities will be exploited. With the WLAN-based VoIP communication described these result, above all, from the fact that the terminal devices used therefore can go missing or be stolen and, because their functions frequently go beyond the functions of telephony, for example to those such as e-mail access to the company network, to contact information and date information, thereby make it possible for unauthorized third parties to access sensitive data.

A known way of increasing the security is to require the input of a PIN by the user when a WLAN telephone is switched on. Also known is the taking into consideration of the location data for a subscriber in making a decision about granting access (Location based Access Control).

Also known, in the case of so-called smart phones based on the Symbian operating system, is the reporting of any misappropriation, where the result of this report is that a command is sent to these devices, over a public mobile radiocommunication network, which leads to all the data stored in the device being deleted. This method is known as “remote wipe”.

However, if the device does not log into a mobile radiocommunication network, whether because the PIN has not been guessed or because an unauthorized third party knows of the remote wipe mechanism and avoids a login, there is a danger of access to the data stored locally in the device.

The object underlying the invention is to specify a method and an arrangement which permits the secure use of cordless VoIP in private networks.

This object is achieved by the independent claims.

In the case of the method in accordance with the invention for operating a cordless VoIP terminal device, in particular one which functions in accordance with the IEEE 802.11 standard or its derivatives, in a private network, in particular a company network, where the VoIP terminal device is authorized to access the network, the VoIP terminal device is only released to access data, which can be called up by the device with the help of a standard interface which makes the data access possible, if the VoIP terminal device has been successfully logged into the private network.

By this means, access to confidential data is made more difficult if the VoIP terminal device gets lost or is misappropriated, and an unauthorized third party comes into possession of the VoIP terminal device in this way. Because access is only granted after the device has logged into the network, the third party must be located within the radio coverage area of the network. A successful attack, i.e. gaining access to the confidential data stored on the VoIP terminal device, is made more difficult because to do so the attacker must be present with the misappropriated VoIP terminal device in the radio coverage area of the private network. Because the release carried out in accordance with the invention is only effected when logging into the private network in which the VoIP terminal device is authorized, the logging-in procedure for an external network is of no help to the unauthorized third party in getting to the data.

The standard interfaces concerned can be physical interfaces, (e.g. USB, serial, IrDA), logical interfaces (device-internal programming interfaces) or equally a screen on the display (user interface).

The validity of the release ends when the VoIP device is no longer logged into the private network. Furthermore, the validity of the release can also be terminated after a maximum validity duration.

It is advantageous here if the method is developed in such a way that after the login by the VoIP terminal device a status flag is set to indicate the release.

This status flag can be implemented internally in the VoIP device, in a memory. It is set by the VoIP device itself when a successful login is performed. As an alternative to the release when a login to the private network is successful, it is also possible for the release to be effected only when the release is signaled by a message transmitted to the VoIP terminal device. This makes it possible for the private network to handle a VoIP terminal device which is identified in the private network's login database as lost or misappropriated in such a way that even in the event of a successful login to the private network no release is effected for access to sensitive data.

By this means, a simple method is made available by which to effect release signaling, because in general it is sufficient to set one data bit as the flag. For this purpose it is possible to use, for example, an unused bit in the data packet headers, so that the invention can be implemented in existing networks with no problem and little cost.

An alternative development consists in communicating to the VoIP terminal device as part of the login a first message, originating from the private network, and to have the release effected as a result of the receipt of this first message. By comparison with the preceding approach, this would be a suggestion particularly when additional data are required for the release. For example if the context or scope of the data release changes.

It is, furthermore, possible to communicate to the VoIP terminal device that the release only relates to a part of the sensitive data. This makes it possible to specify which data can be accessed under particular login procedures. For example, it enables the effect to be achieved that complete data is only accessible if the VoIP terminal device is connected into the private network via a WLAN access point in the office building, whereas for an access via an off-site WLAN access point only restricted access to data is granted, e.g. only to contact data.

If the method is developed in such a way that, in the case when information is present within the private network identifying the terminal device as misappropriated then the receipt of the first message causes the deletion of that part of the data which can be called up, and which is stored in the VoIP terminal device, this achieves the effect that even if an unauthorized third party does manage to log in to the private network without being recognized he is nevertheless not granted access. In addition, this approach has the advantage that the sensitive data is then permanently protected against accesses by unauthorized parties.

It is of further advantage if the release is effected in such a way that the use of the standard interfaces on the part of the VoIP terminal device is unblocked. This development provides an efficient realization, because access to data will generally be made via such interfaces. If the functioning of these interfaces is made dependent on the release, then it becomes almost impossible to access the data in any normal way.

It is particularly advantageous in addition to develop the method in such a way that at least a part of the data which can be called up, in particular that part stored on the VoIP terminal device, is held in store in encrypted form in a terminal device memory. By this means, account is taken of any attempts at manipulation which have the objective of getting to the data which is blocked or unreleased, as applicable, by circumventing the blocked normal data access options, in particular those provided by the standard interfaces, for example by direct manipulation of the storage modules, and to make such manipulation more difficult for an unauthorized third party in that he cannot extract any sensitive data without the associated encryption keys.

This advantage is further strengthened if the method is developed in such a way that any key required for the decryption of stored data is stored in the VoIP terminal device in such a way, in particular in a so-called trusted platform module, that it is only available for use in decryption after a successful login, because a module of this type makes the manipulation attempts mentioned more difficult, so that the keys, and thus also the data, cannot be accessed at all by an attacker, or only at greater cost.

In a development, the key required for the decryption of the stored data is only available for use in decryption after an authentication, effected as part of the login, in particular in accordance with the Extensible Authentication Protocol “EAP”, the Session Initiation Protocol “SIP” on an SIP server and/or on a management server.

This is preferably effected, in particular, in that any key required for the decryption of the stored data is stored in the VoIP terminal device in such a way, in particular in a trusted platform module, that it is only available for use in decryption after the receipt of the first message.

However, as an alternative or an enhancement, as appropriate, it is of yet greater advantage if the method is developed in such a way that any key required for the decryption of the stored data is communicated as part of the login, in particular as part of the first message which is, in particular, structured as a login confirmation message. This ensures that an encryption key is not available if the release of the data has not yet been effected, so that attempted manipulations remain fruitless. This approach is a suitable alternative for this purpose in the case of devices, in particular, which do not provide a trusted platform module. If a trusted platform module is present, then this increases the security of the data yet further.

Security can be increased yet more if the method is developed in such a way that a new key is generated at least once, for a login or logoff by the VoIP terminal device, and preferably for each of them, because this neutralizes any interception or detection of the key which may be effected prior to the misappropriation of the device. To this end, when the VoIP terminal device logs off from the private network, a new cryptographic key is generated, with which the confidential data on the terminal device is encrypted. This key is stored in the private network, so that it can be provided to the terminal device again the next time this terminal device logs in successfully to the private network. The key can either be generated on the terminal device and transmitted to the private network by the terminal device when it logs off, or it is generated in the private network and transmitted to the terminal device when it logs off.

The VoIP terminal device in accordance with the invention makes it possible to realize the method, because it has facilities for carrying out the inventive method, so that its advantages then take effect.

### BRIEF DESCRIPTION OF THE DRAWINGS

By means of a drawing, further details and advantages of the invention are explained below by reference to an exemplary embodiment of the invention.

Shown here in schematic form are:

FIG. 1 a typical scenario underlying the invention,

FIG. 2 a schematic signal diagram for an exemplary embodiment of the inventive method,

FIG. 3 a flow diagram of the exemplary embodiment of the inventive method.

### DETAILED DESCRIPTION OF INVENTION

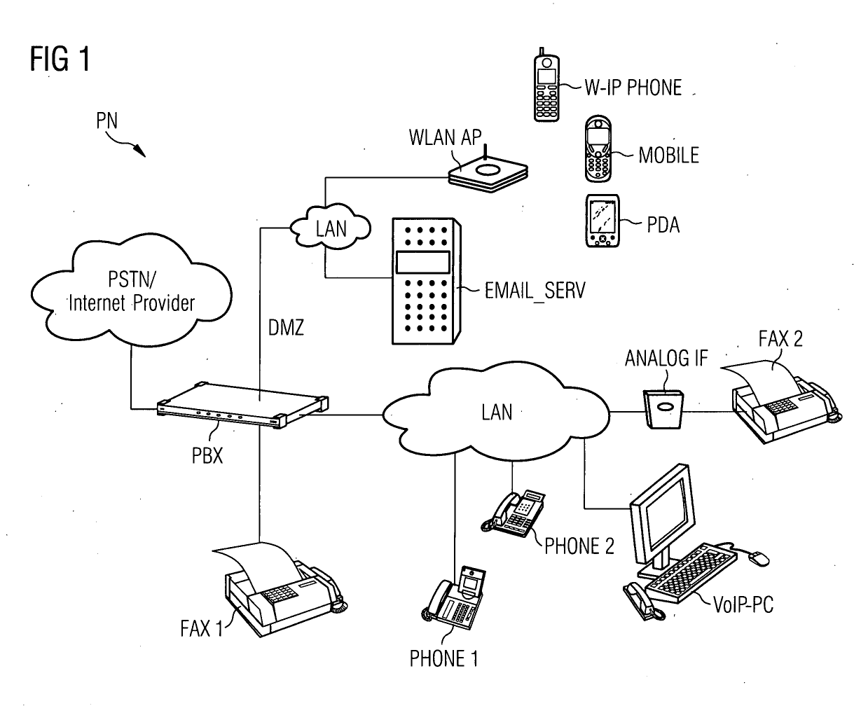

FIG. 1 illustrates a typical scenario, showing a selection of possible elements in a private network PN, as meant in relation to the invention.

The core of the network PN shown is a private branch exchange PBX, which is constructed in such a way that it provides, both for classical telecommunication devices such as a first fax machine FAX1 as shown and for devices from a newer generation, which for communication purposes can communicate via an Internet-protocol-based network such as local networks LAN and/or the Internet, an interface to a telecommunications provider or an Internet provider, in the manner of a classical private branch exchange.

For this purpose, in the scenario illustrated by way of example there are devices linked by cords, via local data networks LAN, such as a first standard telephone PHONE1 and a second telephone PHONE2 which takes the form of an added-feature phone or a computer VoIP-PC suitable for voice communication, which are designed for VoIP communication via IP networks such as the local networks LAN.

In addition, it is possible to connect analog telecommunication terminal devices, such as the second fax machine FAX2 shown, which for this purpose is connected to an appropriate interface device ANALOG IF on the local network LAN.

Apart from this, devices which communicate cordlessly, such as are used for example for wireless communication, in particular such as Wireless Local Area Network (WLAN) devices constructed in accordance with the IEEE 802.11 standard, can also be used for voice communication

Such devices can be, for example, a dual-mode mobile phone W_MOBILE or a terminal device specifically conceived for cordless VoIP communication, WLAN PDA, or a smartphone W_IP PHONE, which are afforded the necessary access to an IP network via a wireless LAN access point WLAN_AP, also shown in the exemplary scenario. In general, these devices offer more than merely the possibility of implementing voice communication. For example, they generally also permit accesses to and the display of data, such as for example e-mails, which are called up from an appropriate server EMAIL_SERV. If the device is a PC, VoIP-PC, equipped with VoIP software and, if appropriate, hardware (headset), then further enhanced data accesses may be suggested, such as to databases.

In this private environment it is thus of extreme importance to protect the—sensitive—data which is available only to this circle or only to the user of a terminal device.

It is, however, precisely in the case of the mobile WLAN terminal devices in this scenario that the loss of devices can easily occur, which allows them to fall into the hands of unauthorized third parties.

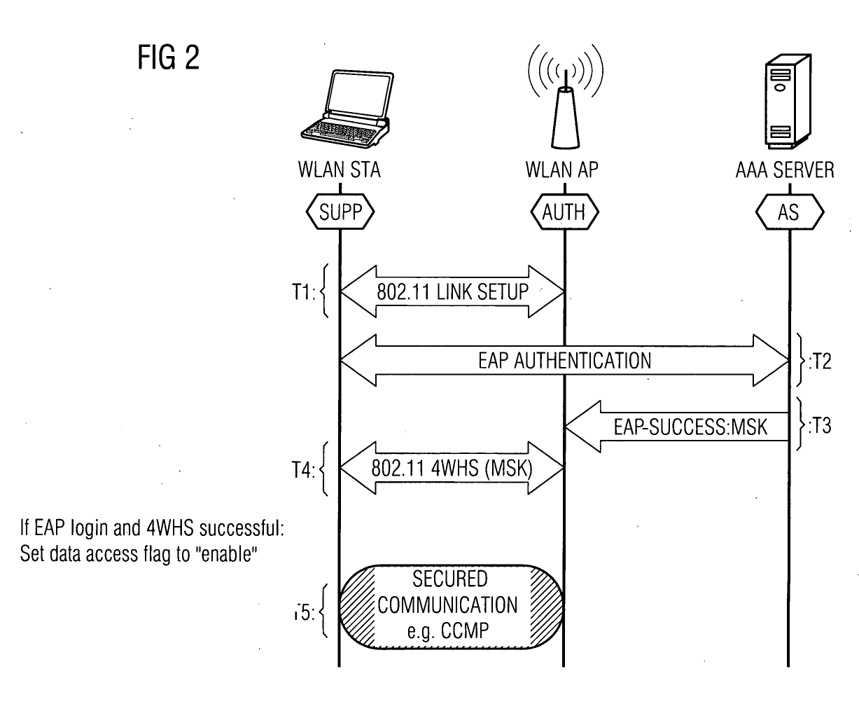

Starting from such a scenario, the method in accordance with the invention now intervenes in accordance with an exemplary embodiment in such a way that access to data, in particular sensitive data, is only possible if an appropriate status flag releases the use of the data interfaces, such as for example IrDA, Bluetooth, RS232, USB or a Lumberg Plug. This status flag, labeled as a data access flag in the example illustrated, should as in the example shown in FIG. 2 only be set to “enable” when a WLAN authentication has been carried out.

The so-called EAP (Extensible Authentication Protocol) protocol is used for the purpose of authenticating nodes or computers. FIG. 2 shows a signal diagram to illustrate an authentication procedure in a conventional WLAN network. The EAP protocol is used in a WLAN to secure the network access. A wide variety of specific authentication procedures, so called EAP methods, can be transported using the EAP protocol, e.g. EAP-TLS, EAP-AKA, PEAP-MSChapV2. When the authentication is performed, a cryptographic key or session key, as applicable, MSK, EMSK (MSK: master session key; EMSK: extended master session key) is determined, this being used subsequently to protect the data communication, for example in the link layer encryption. The authentication of a subscriber is carried out between the subscriber (supplicant) and an authentication server (AAA server). In the case of a successful authentication, the authentication server transmits the result of the authentication and the session key MSK derived from the authentication to the authenticator, for example a WLAN access point AP. Communication between the access node or access point AP and the authentication server is normally carried out using the Radius or Diameter data transmission protocol. In doing this, the session key MSK is transmitted to the access node AP as a data attribute, as part of EAP Success message. The session key MSK which is transmitted is then utilized in an 802.11 4-way handshake, 802.11 4WHS, between the subscriber and the access node, in accordance with the 802.11 IEEE standard. On successful completion, the data access flag can be set to “enable” and protected communication can take place.

Alternatively, or as an addition, it is also conceivable for the data access flag to be set to “enable” only after an IP address is assigned via DCHP. It is also conceivable that this is done, alternatively or as an addition, after a registration at an application server, in particular an SIP server (VoIP, HiPath), or after the receipt of a release message (“Release Data”).

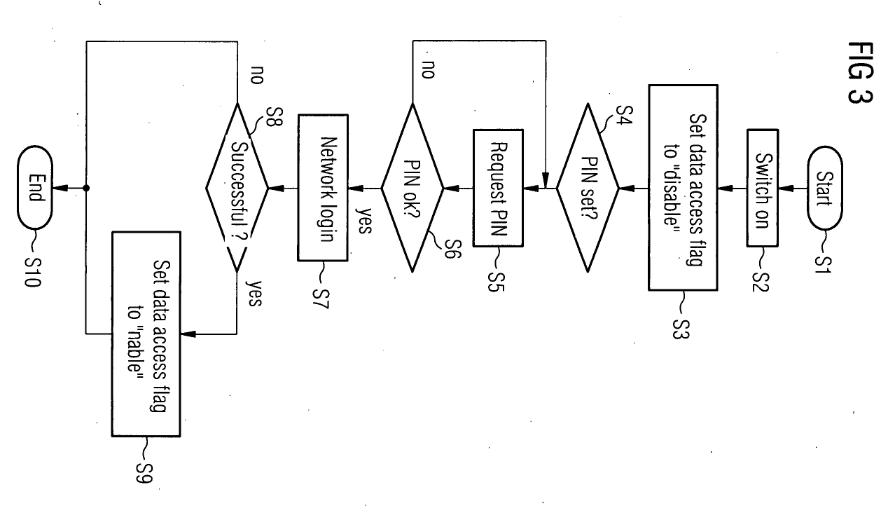

FIG. 3 shows an exemplary embodiment, with the detailed steps for setting the data access flag shown by a flow diagram.

The setting of the flag goes from the state “Start” in a first step S1, through a switch-on of the device performed in a second step S2, to start by setting the data access flag to “disable, in a third step S3. This early explicit blocking of access prevents attempts at manipulation via the standard interfaces during the relatively vulnerable start phase after the device is switched on.

In a fourth step S4, a check is made on whether the PIN which releases the device is set. If so, the user of the device is requested for the PIN in a fifth step S5.

In a sixth step S6 a check is then made on whether the PIN which has been input is correct, i.e. is valid. If so, then a login to the network takes place in a seventh step S7. Otherwise, the request in the sixth step S6 is repeated, and if appropriate the use of the device is blocked, at least temporarily, in the event of a certain number of incorrect inputs.

The network login referred to in the seventh step S7 can then be, for example, the WLAN authentication described above, or a login to an SIP server, the success of which is checked in an eighth step S8.

Depending on the result of the check, if it is negative, i.e. if the network login was not successful, a repeat of the check can be carried out in the manner of a program loop, which can also lead to a block on usage after a termination criterion is reached, if the positive situation of a successful login to the network does not occur.

In the case of the sequence of activities shown in FIG. 3, however, no loop of this type is provided, so that in the negative case the status flag is not set and thus the data access from the terminal device is blocked.

If the login has proceeded successfully, the loop is broken and the data access flag is set to “enable” in a ninth step S9, thus making the standard interfaces usable.

This setting takes the sequence of activities to the “End” state, in a tenth step S10, so that the device is now available for use as intended.

If an attempt is now made, as part of the intended usage, to call up data, a query will always be inserted before the access, asking whether the data access flag is set to “enable”. However, the invention is not restricted to this. It is also conceivable that a check on whether a connection exists to the private network, for example to a company network, via a WLAN—i.e. whether the WLAN link is active—is inserted as a preliminary, or as an alternative to this whether the SIP server is reachable (existing login, response to a ping message).

1.-13. (canceled)

14. A method for operating a cordless VoIP terminal device which functions in accordance with IEEE 802.11 or its derivatives, in a private network, where the VoIP terminal device is authorized to access the network, comprising:
logging into the private network; and
releasing access to data stored on the device accessible via a standard interface for facilitating data access, the release in response to a successful login.

15. The method as claimed in claim 14, further comprising setting a status flag indicating the release in response to the successful login.

16. The method as claimed in claim 14, wherein the release unblocks a use of the standard interface.

17. The method as claimed in claim 14, wherein at least a portion of the data is in an encrypted format.

18. The method as claimed in claim 14, wherein a key required for decryption of encrypted data is stored in the VoIP in a so-called trusted platform module so that it is only accessible for use in decryption after the release of the data.

19. The method as claimed claim 18, wherein the authentication is in accordance with at least the Extensible Authentication Protocol “EAP”, the Session Initiation Protocol “SIP” on an SIP server or on a management server.

20. The method as claimed claim 18, wherein a new key is generated, at least when a login or log-off procedure is carried out for the VoIP terminal device.

21. The method as claimed in claim 14,
wherein the login comprises a first message originating from the private network to be communicated to the VoIP terminal device, and
wherein the release of the access to the data is in response to the receipt of the first message.

22. The method as claimed in claim 21, wherein an item of data is present within the private network indicating the terminal device has been misappropriated, the method further comprises:
deleting at least a portion of the data in response to the receipt of the first message.

23. The method as claimed in claim 21, wherein the release unblocks a use of the standard interface.

24. The method as claimed in claim 22,
wherein at least a portion of the data is in an encrypted format, and
wherein a key required for decryption of encrypted data is stored in the VoIP in a so-called trusted platform module so that it is only accessible for use in decryption the release of the data.

25. The method as claimed in claim 14, further comprises blocking access to the data in response to a log-off from the private network.

26. The method as claimed in claim 14, further comprises blocking access to the data in response to leaving a radio coverage area of the private network.

27. A VoIP terminal device operable in a private network, comprising:
a wireless transceiver in accordance with IEEE 802.11 or its derivatives,
a memory having data accessible via a standard interface,
wherein the standard interface is blocked from accessing the data until unblocked, and
wherein a login to the private network unblocks the unblocks the standard interface in order to access the data.

28. The device as claimed in claim 27, wherein a log-off blocks the standard interface

29. The device as claimed in claim 27, wherein at least a portion of the data is encrypted and the data comprises a key required for decryption of encrypted data, wherein the decryption key is only available when the standard interface is unblocked.

30. The device as claimed in claim 27, wherein a new key is generated, at least when a login or log-off procedure is carried out for the VoIP terminal device.

31. The device as claimed in claim 27,
wherein the login comprises a first message originating from the private network to be communicated to the VoIP terminal device, and
wherein the unblock of the standard interface is in response to the receipt of the first message.

32. The device as claimed in claim 31,
wherein an item of data is present within the private network indicating the terminal device has been misappropriated, and
wherein at least a portion of the data is deleted in response to the receipt of the first message.

28. The device as claimed in claim 27, wherein leaving a radio coverage area of the private network blocks the standard interface
